(19) United States
(12) Patent Application Publication
(10) Pub. No.: US 2014/0017577 A1
(43) Pub. Date: Jan. 16, 2014

(54) AIR ELECTRODE FOR METAL-AIR BATTERY AND METAL AIR BATTERY

(71) Applicants: Keiichi MINAMI, Susono-shi (JP); Sanae OKAZAKI, Suntou-gun (JP)

(72) Inventors: Keiichi MINAMI, Susono-shi (JP); Sanae OKAZAKI, Suntou-gun (JP)

(73) Assignee: TOYOTA JIDOSHA KABUSHIKI KAISHA, Toyota-shi (JP)

(21) Appl. No.: 13/938,365

(22) Filed: Jul. 10, 2013

(30) Foreign Application Priority Data
Jul. 11, 2012 (JP) 2012-155518

(51) Int. Cl. H01M 4/90

(52) U.S. Cl. CPC H01M 4/9016
USPC 429/405

(57) ABSTRACT

An air electrode for a metal-air battery that includes the air electrode, a negative electrode, and an electrolyte provided between the air electrode and the negative electrode. The air electrode includes non-crosslinking oxygen-containing MₓO_{y}-based glass that contains a non-crosslinking oxygen that is an oxygen (O) that bonds to M constituting the MₓO_{y}-based glass and bonds to Ag, MₓO_{y} of the MₓO_{y}-based glass being at least one kind selected from the group of B₂O₃, P₂O₅, SiO₂, GeO₂, and Al₂O₃.

### INCORPORATION BY REFERENCE

The disclosure of Japanese Patent Application No. 2012-155518 filed on Jul. 11, 2012 including the specification, drawings and abstract is incorporated herein by reference in its entirety.

### BACKGROUND OF THE INVENTION

1. Field of the Invention

The present invention relates to an air electrode for a metal-air battery and a metal-air battery provided with the air electrode.

2. Description of Related Art

A metal-air battery that utilizes oxygen as a positive electrode active material has advantages such as that an energy density is high, and reduction in size and weight can be readily realized. Therefore, it is gaining attention as a high capacity battery exceeding a lithium ion secondary battery that is widely used at the present time. As a metal-air battery, for example, a lithium-air battery, a magnesium-air battery, and a zinc-air battery are known. A metal-air battery can charge/discharge by performing a redox reaction of oxygen in an air electrode (positive electrode) and a redox reaction of a metal contained in a negative electrode in a negative electrode. For example, in a metal-air battery (secondary battery) where a conducting ion is a monovalent metal ion, it is considered that the following charge-discharge reaction proceeds. In the following formula, M represents a metal species.

Charge/Discharge Reaction During Discharge

Negative electrode: M→M⁺+e⁻

Air electrode: 2M⁺+O₂+2e⁻→M₂O₂

Charge/Discharge Reaction During Charge

Negative electrode: M⁺+e⁻→M

Air electrode: M₂O₂→2M⁺+O₂+2e⁻

A metal-air battery includes, for example, an air electrode that contains a conductive material and a binder, an air electrode current collector that collects a current of the air electrode, a negative electrode that contains a negative electrode active material (metal or alloy), a negative electrode current collector that collects a current of the negative electrode, and an electrolyte provided between the air electrode and the negative electrode.

Specific examples of metal-air batteries include, for example, what are disclosed in Japanese Patent Application Publication Nos. 2009-518795 (JP 2009-518795A), 07-130404 (JP 07-130404A), and 11-339865 (JP 11-339865A). For example, in JP 2009-518795A, a metal-air battery that includes an active layer that contains a redox catalyst and a bifunctional catalyst selected from La₂O₃, Ag₂O and a spinel is described.

In the case where Ag₂O is contained like in a metal-air battery described in JP 2009-518795A, while oxygen reduction capability in an air electrode is improved, sufficient output characteristics cannot be obtained. Further, in a metal-air battery that contains Ag₂O, in the case where hydrogen is generated by a side reaction in a battery, the hydrogen is reduced to water, because Ag₂O has high hydrogen reduction capability. When hydrogen is present in a battery, this is one of reasons that deteriorate performance of a metal-air battery. Therefore, it is necessary to suppress the generation of hydrogen and to remove the generated hydrogen. However, since the presence of water in a battery also causes the deterioration of metal-air battery, generation of water by reduction of hydrogen does not fundamentally solve the problem. Further, in a lithium-air battery that is a representative example of a metal-air battery, it is very difficult to suppress generation of a slight amount of hydrogen.

### SUMMARY OF THE INVENTION

The present invention provides a metal-air battery that can, while suppressing performance from deteriorating owing to hydrogen, realize an improvement in output characteristics.

An air electrode for a metal-air battery in an embodiment of the present invention including an air electrode, a negative electrode, and an electrolyte provided between the air electrode and the negative electrode, contains non-crosslinking oxygen-containing MₓO_{y}-based glass that contains a non-crosslinking oxygen that is an oxygen (O) that bonds to M constituting MₓO_{y}-based glass (here, MₓO_{y} is at least one kind selected from the group of B₂O₃, P₂O₅, SiO₂, GeO₂, and Al₂O₃) and bonds to Ag. In the air electrode for a metal-air battery having the above structure, Ag that bonds to the non-crosslinking oxygen reacts with hydrogen to generate a metal hydroxide. Therefore, hydrogen can be removed and an output can be improved owing to generation of a metal hydroxide.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a sectional schematic diagram showing one embodiment of a metal-air battery of the present invention; and

FIG. 2 is a diagram showing current-voltage curves of Example 1, Example 2 and Comparative Example 1.

### DETAILED DESCRIPTION OF EMBODIMENTS

An air electrode for a metal-air battery including an air electrode, a negative electrode, and an electrolyte provided between the air electrode and the negative electrode, contains non-crosslinking oxygen-containing MₓO_{y}-based glass that contains a non-crosslinking oxygen, that is, an oxygen (O) that bonds to M constituting MₓO_{y}-based glass (here, MₓO_{y} is at least one kind selected from the group of B₂O₃, P₂O₅, SiO₂, GeO₂, and Al₂O₃) and bonds to Ag.

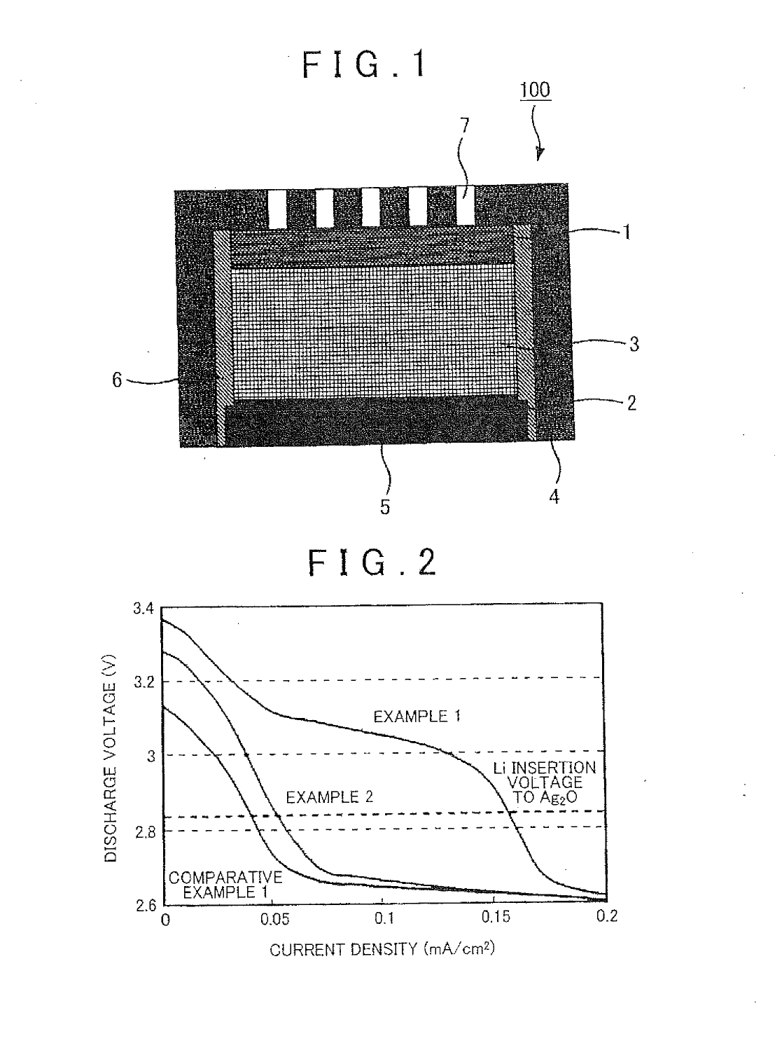

Hereinafter, an air electrode for a metal-air battery of the present invention (hereinafter, in some cases, referred to as an air electrode) will be described with reference to FIG. 1. FIG. 1 is a sectional schematic diagram showing one embodiment of a metal-air battery provided with an air electrode of the present invention. In a metal-air battery 100 of FIG. 1, an air electrode 1, a negative electrode 2, and an electrolyte 3 are laminated so as to dispose the electrolyte 3 between the air electrode 1 and the negative electrode 2, that is, the electrolyte 3 intermediates between the air electrode 1 and the negative electrode 2. The air electrode 1, the negative electrode 2 and the electrolyte 3 are housed in a battery case configured of an air electrode canister 4 and a negative electrode canister 5. The air electrode canister 4 and the negative electrode canister 5 are fixed by means of a gasket 6.

The air electrode 1 is a field of an electrode reaction, in which oxygen is an active material, and includes a conductive material (for example, carbon black), Ag₂O—B₂O₃-based silver ion conducting glass, and a binder (for example, polytetrafluoroethylene). The air electrode 1 has a porous structure and is supplied with oxygen (air) that is taken in from oxygen intake holes 7 disposed to the air electrode canister 4.

The negative electrode 2 contains a negative electrode active material (for example, Li metal) capable of releasing and storing a lithium ion (metal ion) that is a conducting ion species. The electrolyte 3 has conductivity of lithium ion (metal ion) that is a conducting ion species (for example, an electrolytic solution obtained by dissolving a lithium salt in a nonaqueous solvent) and is impregnated in a separator made of polyolefin-based porous material.

Inventors of the present invention have found that when non-crosslinking oxygen-containing MₓO_{y}-based glass that contains a non-crosslinking oxygen, that is, an oxygen (O) that bonds to M constituting MₓO_{y}-based glass (here, MₓO_{y} is at least one kind selected from the group of B₂O₃, P₂O₅, SiO₂, GeO₂, and Al₂O₃) and bonds to Ag is added to an air electrode for a lithium-air battery, output characteristics of a metal-air battery is improved. This is considered because in non-crosslinking oxygen-containing MₓO_{y}-based glass having silver ion conductivity, an M-O bond having a non-crosslinking oxygen forms an M-OH bond with hydrogen present in a battery, owing to a reduction action of Ag that bonds with the non-crosslinking oxygen (ionic bond), and a new reaction that generates LiOH proceeds. Since formation of an M-OH bond in the air electrode promotes generation of LiOH and a generation reaction of LiOH proceeds at a high electric potential of about 3 V, output characteristics of a battery is improved. Further, the LiOH is generated by a reaction that consumes hydrogen in a battery. When hydrogen is generated in a battery, problems that an electrolytic solution leaks owing to an increase of internal pressure of a battery, and electron conductivity is deteriorated owing to the hydrogen bubbles. That is, the present invention utilizes hydrogen that causes such the deterioration of battery performance, and as a result, an improvement in output is achieved and also the hydrogen can be removed.

Hereinafter, a structure of an air electrode for a metal-air battery of the present invention will be detailed. In the present invention, a metal-air battery means a battery where a redox reaction of oxygen that is a positive electrode active material is performed in an air electrode, a redox reaction of a metal is performed in a negative electrode, and metal ions are conducted by an electrolyte provided between the air electrode and the negative electrode. Examples of kinds of metal-air batteries include a lithium-air battery, a sodium-air battery, a potassium-air battery, a magnesium-air battery, a calcium-air battery, an aluminum-air battery, a zinc-air battery and an iron-air battery. Since, in particular, a lithium-air battery contains a lithium metal in a negative electrode, a slight amount of hydrogen is inevitably generated. Therefore, it can be said that in output improvement effect and solution of problems due to hydrogen, which were described above, a particularly high effect can be exerted. Further, it is readily assumed that also in the metal-air batteries other than the lithium-air battery, there is enough likelihood of generation of hydrogen due to a side reaction, which will cause battery performance deterioration, and that, by forming the M-OH bond, generation of metal hydroxide is promoted and output characteristics of battery will be improved. Therefore, when an air electrode of the present invention is adopted in a metal-air battery other than a lithium-air battery, the effects such as an improvement in output characteristics and removal of hydrogen can also be obtained. Further, in the present invention, an air-metal battery may be either a primary battery or a secondary battery. However, a secondary battery is preferable.

The non-crosslinking oxygen-containing MₓO_{y}-based glass contained in the air electrode of the present invention is at least one kind of oxide glasses (MₓO_{y}-based glass) selected from the group of B₂O₃, P₂O₅, SiO₂, GeO₂, and Al₂O₃, and it is not particularly limited as far as it contains a non-crosslinking oxygen that bonds with M and Ag that constitute the MₓO_{y}-based glass. As the MₓO_{y}-based glass, B₂O₃-based glass is particularly preferred. The MₓO_{y}-based glass has a structure where the minimum structural units configured of M and O are linked with oxygen shared. It is known that when an alkali oxide is added to such MₓO_{y}-based glass, an alkali metal bonds (ionic bond) to a shared oxygen (crosslinking oxygen) to break an M-O-M bond to convert a crosslinked oxygen into a non-crosslinking oxygen. In the present invention, by adding a silver-containing compound such as Ag₂O, an M-O-M network of MₓO_{y}-based glass is broken by Ag, and an M-O⁻ . . . Ag⁺ bond having a non-crosslinking oxygen can be introduced in the MₓO_{y}-based glass. This allowed an improvement in the output characteristics and hydrogen removal as was described above. Specifically, for example, B₂O₃-based glass has a BO₃ planar equilateral triangle as the minimum structural unit, and has a structure where the BO₃ planar equilateral triangles are linked with oxygen shared. In the B₂O₃-based glass like this, when a silver-containing compound such as Ag₂O is added, Ag breaks a B—O—B network of the B₂O₃-based glass to be able to introduce a B—O⁻ . . . Ag+ bond having a non-crosslinking oxygen into the B₂O₃-based glass.

In the non-crosslinking oxygen-containing MₓO_{y}-based glass, among oxygens that bond with M, a ratio of non-crosslinking oxygens that bond to M and bond to Ag is preferably 25% or more and particularly preferably 50% or more from the viewpoint of the hydrogen removal effect and output characteristics improvement, and preferably 75% or less from the viewpoint of a bonding state of oxygen. A ratio of the non-crosslinking oxygens is represented by setting a total amount of oxygens that bond to M contained in the MₓO_{y}-based glass to 100%.

Examples of the non-crosslinking oxygen-containing MₓO_{y}-based glasses include Ag₂O—B₂O₃-based glass, Ag₂O—P₂O₅-based glass, Ag₂O—SiO₂-based glass, Ag₂O—GeO₂-based glass and Ag₂O—Al₂O₃-based glass, and among these, B₂O₃-based glass is preferable.

A method of manufacturing a non-crosslinking oxygen-containing MₓO_{y}-based glass is not particularly limited. For example, a known method of manufacturing ion conductive glass can be adopted. For example, a method where MₓO_{y} glass and a silver oxide such as Ag₂O are mechanochemically treated can be cited. Examples of mechanochemical treatments include a ball mill such as a planetary ball mill, a milling treatment such as a beads mill, and a jet mill. Specific examples of milling treatment with a ball mill include a method where starting materials (MₓO_{y} glass such as B₂O₃ glass and a silver-containing compound such as Ag₂O) are charged in a reactor together with balls of ceramic such as zirconia or alumina, and the reactor and the balls in the reactor are rotated. Specific conditions of ball milling can be set to, for example, a rotation velocity of about 300 to 500 rpm and a rotation time of about 10 to 20 hrs.

In the non-crosslinking oxygen-containing MₓO_{y}-based glass, among oxygens that bond to M, a ratio of non-crosslinking oxygens that bond to M and bond to Ag can be controlled by adjusting a charge ratio of the MₓO_{y} glass and a silver-containing compound, for example, when the non-crosslinking oxygen-containing MxOy-based glass is manufactured. For example, in Ag₂O—B₂O₃-based glass, when a ratio of non-crosslinking oxygens that bond to B (boron) and Ag is to be 25%, a charge ratio of Ag₂O and B₂O₃ may be set to 25 (Ag₂O): 75 (B₂O₃) by mol.

In the air electrode of the present invention, a content of the non-crosslinking oxygen-containing MₓO_{y}-based glass is not particularly limited. However, from the viewpoint of hydrogen removal effect and output characteristics improvement, it is preferably 10% by weight or more, particularly preferably 20% by weight or more, more particularly preferably 30% by weight or more. Further, from the viewpoint of electron conductivity, it is preferably 50% by weight or less.

The air electrode of the present invention usually contains at least a conductive material in addition to the non-crosslinking oxygen-containing MₓO_{y}-based glass. The conductive material is not particularly limited, and a conductive carbon material can be used for example. Examples of the conductive carbon materials include carbon black, activated carbon and carbon fiber (for example, carbon nanotube, and carbon nano-fiber). From the viewpoint of ensuring a space of a reaction field in an air electrode, the conductive carbon material preferably has a porous structure, in particular, a high pore volume of 1 ml/g or more. A pore volume of the conductive material can be measured by, for example, a BJH method by nitrogen absorption measurement. A content of the conductive material in the air electrode is, though depending on the density and a specific surface area of the conductive material, preferably 20% by weight or more, for example, particularly preferably 40% by weight or more, and 89% by weight or less.

The air electrode may contain an air electrode catalyst for promoting a reaction of oxygen in the air electrode. The air electrode catalyst like this may be supported on the conductive material described above. The air electrode catalysts are not particularly limited, but may include, for example, organic materials such as phthalocyanine compounds including cobalt phthalocyanine, manganese phthalocyanine, nickel phthalocyanine, tin phthalocyanine oxide, titanium phthalocyanine, and dilithium phthalocyanine; naphtocyanine compounds including cobalt naphtocyanine; and porphyrin compounds including iron porphyrin, metal oxides such as MnO₂, CeO₂, Co₃O₄, NiO, V₂O₅, Fe₂O₃, ZnO, CuO, LiMnO₂, Li₂MnO₃, LiMn₂O₄, Li₄Ti₅O₁₂, Li₂TiO₃, LiNi_{1/3}Co_{1/3}Mn_{1/3}O₂, LiNiO₂, LiVO₃, Li₅FeO₄, LiFeO₂, LiCrO₂, LiCoO₂, LiCuO₂, LiZnO₂, Li₂MoO₄, LiNbO₃, LiTaO₃, Li₂WO₄, Li₂ZrO₃, NaMnO₂, CaMnO₃, CaFeO₃, MgTiO₃, and KMnO₂; and inorganic materials such as precious metals such as Au, Pt, and Ag. Further, also a composite obtained by combining a plurality of the materials listed above can be used as an air electrode catalyst. A content of the air electrode catalyst in the air electrode is preferably, for example, in the range of 1% by weight to 90% by weight.

The air electrode preferably contains a binder from the viewpoint of fixing the non-crosslinking oxygen-containing MₓO_{y}-based glass, the conductive material, and the air electrode catalyst. Examples of the binders include polyvinylidene fluoride (PVdF), polytetrafluoroethylene (PIPE), and styrene-butadiene rubber (SBR). A content of the binder in the air electrode is preferably in the range of 1% by weight to 30% by weight, for example. A thickness of the air electrode is, though different depending on use of a metal-air battery, for example, preferably in the range of 500 μm or less, particularly preferably in the range of 300 μm or less, and more particularly preferably in the range of 100 μm or less.

The air electrode may be provided with an air electrode current collector for collecting a current of the air electrode. The air electrode current collector may have either a porous structure or a dense structure as long as it has desired electron conductivity. However, from the viewpoint of diffusivity of air (oxygen), a porous structure is preferable. Examples of the porous structures include a mesh structure where structural fibers are regularly arranged, a nonwoven fabric structure where structural fibers are arranged at random, and a three-dimensional network structure having independent pores or connected pores Examples of materials for the air electrode current collector include; metal materials such as stainless steel, nickel, aluminum, iron, titanium, and copper; carbon materials such as carbon fiber, carbon paper and carbon cloth; and ceramic materials having high electron conductivity such as titanium nitride. As preferable specific air electrode current collectors, porous structures such as carbon paper, carbon cloth, and metal mesh can be cited, and porous carbon is particularly preferable. A thickness of the air electrode current collector is, though not particularly limited, preferably in the range of 10 μm to 1000 μm for example, and particularly preferably in the range of 20 μm to 400 μm. A battery case of a metal-air battery, which will be described below, may combine a function as a current collector of an air electrode.

A method of manufacturing an air electrode is not particularly limited. For example, a material obtained by mixing the non-crosslinking oxygen-containing MₓO_{y}-based glass, the conductive material, and other materials such as the binder can be used to form an air electrode. Specifically, the materials that form a positive electrode and a solvent are kneaded, the resulted material for an air electrode is rolled or coated on a base material and molded, and, as required, the molded material is dried, pressurized, or heated to manufacture an air electrode, Thus-manufactured air electrode is appropriately superposed with the air electrode current collector, and a molded electrolyte or a separator impregnated with an electrolytic solution, and, by pressurizing or heating as required, the air electrode can be laminated together with these members.

A solvent that is used when the air electrode is prepared can be optionally selected without particular limitation as long as it has volatility. Specifically, ethanol, acetone, INN-dimethylformamide (DMF), and N-methyl-2-pyrrolidone (NMP) can be cited. A method of coating the material for air electrode is not particularly limited. General methods such as a doctor blade method, an ink-jet method, and a spray method can be used. Further, a method of rolling the material for air electrode is not particularly limited. For example, a roll press can be used.

Next, a metal-air battery of the present invention will be described. A metal-air battery of the present invention includes an air electrode, a negative electrode, and an electrolyte provided between the air electrode and the negative electrode, and the air electrode is an air electrode for a metal-air battery of the present invention as described above. The metal-air battery of the present invention, which is provided with such air electrode, has high output characteristics, and, further, can realize also an improvement in battery performance such as electron conductivity owing to hydrogen removal. Hereinafter, respective constitutions of the metal-air battery will be described.

The negative electrode includes a negative electrode active material capable of releasing and storing metal ions (conducting ions). The negative electrode may be provided with a negative electrode current collector that collects a current of the negative electrode. The negative electrode active material is not particularly limited as long as it can release and store conducting ion species typically metal ions. For example, a metal simple substance, an alloy, a metal oxide, a metal sulfide and a metal nitride, which contain a metal ion that is a conducting ion species can be cited. Further, also a carbon material can be used as a negative electrode active material. As a negative electrode active material, a metal simple substance or an alloy is preferable, and a metal simple substance is particularly preferable. As the metal simple substances, for example, lithium, sodium, potassium, magnesium, calcium, aluminum, zinc and iron can be cited. As the alloys, alloys that contain at least one kind of the metal simple substances can be cited. More specifically, as a negative electrode active material of a lithium-air battery, for example, lithium metal; lithium alloys such as lithium aluminum alloy, lithium tin alloy, lithium lead alloy, and lithium silicon alloy; lithium oxide; lithium composite oxides such as lithium titanate; lithium sulfides such as lithium tin sulfide and lithium titanium sulfide; lithium nitrides such as lithium cobalt nitride, lithium iron nitride and lithium manganese nitride; and carbon materials such as graphite can be cited, and, among these, lithium metal is preferable.

The negative electrode may contain at least a negative electrode active material. However, as required, it may contain a binder for fixing the negative electrode active material. For example, when a foil-like metal or alloy is used as a negative electrode active material, a negative electrode can be formed into a form having the negative electrode active material alone. However, when a powdery negative electrode active material is used, a negative electrode can be formed into a form that contains the negative electrode active material and a binder. Further, the negative electrode may contain a conductive material. The kind and the amount used of the binder and the conductive material can be set in a mariner the same as those described above for the air electrode.

A material of the negative electrode current collector is not particularly limited as long as it has conductivity. For example, copper, stainless steel and nickel can be cited, and among these, stainless or nickel is preferable. As a shape of the negative electrode current collector, for example, foil, plate and mesh can be cited. Further, a battery case may have a function as a negative electrode current collector.

Methods of manufacturing the negative electrode and the negative electrode current collector are not particularly limited. For example, by superposing and pressurizing the foil-like negative electrode active material and negative electrode current collector, the negative electrode and the negative electrode current collector can be laminated. Alternatively, when a negative electrode material that contains the negative electrode active material and the binder is prepared, and the negative electrode material is coated on a base material (for example, the negative electrode current collector) and dried, the negative electrode and the negative electrode current collector can be laminated.

The electrolyte intermediates between an air electrode and a negative electrode and performs metal ion conduction between the air electrode and the negative electrode. The electrolyte is not particularly limited as long as it can conduct metal ions between the air electrode and the negative electrode. An electrolytic solution, an electrolyte gel, a solid electrolyte, a solid polymer and mixtures thereof can be used as the electrolyte.

As an electrolytic solution, for example, a nonaqueous electrolytic solution that contains a support electrolyte salt and a nonaqueous solvent can be cited. The nonaqueous solvent is not particularly limited. For example, propylene carbonate (PC), ethylene carbonate (EC), vinylene carbonate, dimethyl carbonate (DMC), ethyl methyl carbonate (EMC), diethyl carbonate (DEC), methylpropyl carbonate, isopropiomethyl carbonate, ethyl propionate, methyl propionate, γ-butyrolactone, ethyl acetate, methyl acetate, tetrahydrofuran, 2-methyltetrahydrofuran, ethylene glycol dimethyl ether, ethylene glycol diethyl ether, acetonitrile (AcN), dimethyl sulfoxide (DMSO), diethoxyethane; dimethoxymethane (DME), and tetraethylene glycol dimethyl ether (TEGDME) can be cited.

Further, an ionic liquid may be used as a nonaqueous solvent. As the ionic liquid, for example, aliphatic quaternary ammonium salts such as N,N, N-trimethyl-N-propylammonium bis(trifluoromethanesulfonyl)amide [abbreviated name: TMPA-TFSA], N-methyl-N-propylpiperidinium bis(trifluoromethanesulfonyl)amide [abbreviated name: PP13-TFSA], N-methyl-N-propylpyrrolidinium bis(trifluoromethanesulfonyl)amide [abbreviated name: P13-TFSA], N-methyl-N-butylpyrrolidinum bis(trifluoromethanesulfonyl)amide [abbreviated name: P14-TFSA], and N,N-diethyl-N-methyl-N-(2-methoxyethyl)ammonium bis(trifluoromethanesulfonyl)amide [abbreviated name: DEME-TFSA]; and alkyl imidazolium quaternary salts such as 1-methyl-3-ethyl imidazolium tetrafluoroborate [abbreviated name: EMIBF₄], 1-methyl-3-ethyl imidazolium bis(trifluoromethanesulfonyl)amide [abbreviated name: EMITFSA], 1-allyl-3-ethyl imidazolium bromide [abbreviated name: AEImBr], 1-allyl-3-ethyl imidazolium tetrafluoroborate [abbreviated name: AEImBF₄], 1-allyl-3-ethyl imidazolium bis(trifluoromethanesulfonyl)amide [abbreviated name: AEImTFSA], 1,3-diallyl imidazolium bromide [abbreviated name: AAImBr], 1,3-diallyl imidazolium tetrafluoroborate [abbreviated name: AAImBF₄], and 1,3-diallyl imidazolium bis(trifluoromethanesulfonyl)amide [abbreviated name: AAImTFSA] can be cited.

Since a side reaction can be suppressed, a nonaqueous solvent is preferably high in electrochemical stability against an oxygen radical. Specifically, AcN, DMSO, DME, PP13-TFSA, P13-TFSA, P14-TFSA, TMPA-TFSA and DEME-TFSA are preferable.

In the nonaqueous electrolytic solution, a support electrolyte salt is acceptable so far as it has solubility to a nonaqueous solvent and develops desired metal ion conductivity. Usually, a metal salt that contains a metal ion that is desired to be conducted can be used. For example, in the case of a lithium-air battery, a lithium salt can be used as a support electrolyte salt. As a lithium salt, inorganic lithium salts such as LiPF₆, LiBF₄, LiClO₄, LiAsF₆, LiOH, LiCl, LiNO₃, and Li₂SO₄ can be cited. Further, organic lithium salts such as CH₃CO₂Li, lithium bisoxalate borate (abbreviated name: LiBOB), LiN(CF₃SO₂)₂ (abbreviated name: LiTFSA), LiN(C₂F₅SO₂)₂ (abbreviated name: LiBETA), and LiN(CF₃SO₂)(C₄F₉SO₂) can be used. In a nonaqueous electrolytic solution, a concentration of the support electrolyte salt can be set, though not particularly limited, in the range of 0.5 mol/L to 3 mol/L for example.

Further, an aqueous electrolytic solution that contains a support electrolyte salt and water may be used as the electrolytic solution. In the aqueous electrolytic solution, the support electrolyte salt is not particularly limited as long as it has solubility to water and can develop desired ionic conductivity. Usually, a metal salt that contains a metal ion that is desired to be conducted can be used. For example, in the case of the lithium-air battery, for example, lithium salts such as LiOH, LiCl, LiNO₃, Li₂SO₄, and CH₃COOLi can be used.

The electrolytic solution can be incorporated into a battery in a state where it is impregnated in a separator that has an insulating property that can ensure an insulating property between an air electrode and a negative electrode, and a porous structure that can retain the electrolytic solution. As the separator, without particularly limiting, known materials and porous structures can be adopted. As the materials of the separator, for example, insulating resins such as polyolefins including polyethylene and polypropylene and glasses can be cited. Further, as a porous structure of the separator, for example, a mesh structure where structural fibers are regularly arranged, a nonwoven fabric structure where structural fibers are arranged at random, and a three-dimensional network structure having independent pores or coupling holes can be cited. A thickness of the separator may be, for example, about 10 to 500 μm without particular limitation.

As the electrolyte gel, those which are obtained by gelating the electrolytic solutions such as described above can be cited. For example, as a method of gelating a nonaqueous electrolytic solution, a method where a polymer such as polyethylene oxide (PEO), polyacrylonitrile (PAN), polyvinylidene fluoride (PVDF) or polymethyl methacrylate (PMMA) is added in a nonaqueous electrolyte solution can be cited. An electrolyte gel can be formed, for example, in such a manner that, after the polymer and the electrolytic solution, which were described above are mixed, the mixture is coated by casting on a base material and dried, the dried mixture is peeled off the base material, and cut into pieces as required.

The solid electrolyte can be appropriately selected in accordance with a conductive metal ion without particular limitation. For example, in the case of a lithium-air battery, NASICON oxides represented by LiₐX_{b}Y_{c}P_{d}Oₑ (X represents at least one kind selected from the group of B, Al, Ga, In, C, Si, Ge, Sn, Sb and Se, Y represents at least one kind selected from the group of Ti, Zr, Ge, In, Ga, Sn and Al, and a to e satisfy relationships of 0.5<a<5.0, 0≦b<2.98, 0.5≦c<3.0, 0.02<d≦3.0, 2.0<b+d<4.0, and 3.0<e≦12.0); perovskite oxides such as LiₓLa₁₋ₓTiO₃; LISICON oxides such as Li₄XO₄—Li₃YO₄ (X represents at least one kind selected from Si, Ge and Ti, and Y represents at least one kind selected from P, As and V) and Li₃DO₃—Li₃YO₄ (D represents B, Y represents at least one kind selected from P, As and V); and garnet oxides of Li—La—Zr—O based oxides such as Li₇La₃Zr₂O₁₂ can be cited. The solid electrolyte can be molded, for example, by rolling, or by preparing a slurry by mixing with a solvent, by coating, and by drying.

The metal-air battery of the present invention may have other constituent members than the air electrode, electrolyte and negative electrode, which were described above, The metal-air battery usually has a battery case for housing an air electrode, a negative electrode and an electrolyte. A shape of the battery case is not particularly limited. Specifically, a coin shape, a flat plate shape, a cylindrical shape, and a laminate shape can be cited. The battery case may be either an open atmosphere type or a hermetically sealed type as long as it can feed oxygen to the air electrode. The open atmosphere type battery case has a structure where at least an air electrode is capable of sufficiently coming into contact with atmosphere. For example, like a metal air battery 100 shown in FIG. 1, a structure having oxygen-intake holes 7 that communicate with an air electrode 1 can be cited. To the oxygen-intake holes 7, an oxygen transmitting membrane that can selectively transmit oxygen may be disposed. The oxygen transmitting membrane is preferably capable of blocking water (moisture) and carbon dioxide in air from coming into a battery case. As a specific oxygen transmitting membrane, for example, a polysiloxane-based membrane can be cited. Further, to the air-intake hole, a water-repelling membrane such as a polytetrafluoroethylene membrane may be disposed. An oxygen transmitting membrane may combine a function of a water-repelling membrane. On the other hand, to the hermetically sealed type battery case, an inlet pipe and an outlet pipe of oxygen (air) that is a positive electrode active material can be provided. A concentration of oxygen fed to a metal-air battery is preferable to be higher, and pure oxygen is particularly preferable.

When a metal-air battery has a structure where a laminate in which an air electrode, an electrolyte and a negative electrode are arranged in this order is repeatedly stacked in many layers (for example, laminate structure or wound structure), from the viewpoint of safety, it is preferable to have a separator between an air electrode and a negative electrode each of which belongs to a laminate different from each other, As the separator like this, for example, a porous membrane of polyethylene or polypropylene; and a non-woven fabric such as a resin non-woven fabric or a glass fiber non-woven fabric can be cited. Further, each of an air electrode current collector and a negative electrode current collector can be provided with a terminal that constitutes a connecting part with the exterior. As a method of manufacturing a metal-air battery of the present invention, a general method can be adopted without particular limitation.

In the non-crosslinking oxygen-containing MₓO_{y}-based glass, among oxygens (O) that bond to the M, the non-crosslinking oxygens may be 25% or more. Further, in the non-crosslinking oxygen-containing MₓO_{y}-based glass, among oxygens (O) that bond to the M, the non-crosslinking oxygens may be 50% or more. As the MₓO_{y}-based glass, for example, B₂O₃-based glass may be used. Further, as the non-crosslinking oxygen-containing MₓO_{y}-based glass, for example, Ag₂O—B₂O₃-based glass may be used.

As a metal-air battery, the negative electrode may contain lithium metal. When the negative electrode contains lithium metal, hydrogen tends to be generated in a metal-air battery. However, in the above structure, hydrogen can be removed effectively, and high output can be acquired.

### Example 1

Preparation of a metal-air battery will be described. In the beginning, preparation of an air electrode will be described. Firstly, Ag₂O—B₂O₃-based glass was manufactured in a manner as shown below. That is, Ag₂O and B₂O₃ were mixed at a mole ratio of 50:50 and milled, thereby Ag₂O—B₂O₃-based glass (hereinafter, referred to as 50Ag₂O-50B₂O₃ glass) was prepared. In the milling treatment, ZrO₂ balls and predetermined amounts of Ag₂O and B₂O₃ were charged in a ZrO₂ pot and milled. In the 50Ag₂O-50B₂O₃ glass, a ratio of non-crosslinking B—O bonds was 50% (see, Table 1). Subsequently, carbon black (Ketjen black, manufactured by Ketjen Black International), 50Ag₂O—B₂O₃ glass, and a PTFE binder (manufactured by Daikin Industries, Ltd.) were kneaded at a weight ratio of 40:30:30 with an ethanol solvent, after that, the mixture was rolled by roll press and molded into a sheet. The sheet was, after vacuum-drying, cut, and an air electrode was obtained.

Preparation of a lithium-air battery will be described. In N,N-diethyl-N-methyl-N-(2-methoxyethyl)ammonium bis(trifluoromethanesulfonyl)amide (DEME-TFSA, manufactured by Kanto Chemical Co., Inc.), lithium bistrifluoromethanesulfonyl amide (LiTFSA, manufactured by Kishida Chemical Co., Ltd.) was mixed and dissolved to be a concentration of 0.35 mol/kg under an Ar atmosphere overnight, and an electrolytic solution was prepared. As a separator, a polyolefin-based porous body was prepared. Further, as a negative electrode, metal Li (manufactured by Honjyo Kinzoku K. K.) was prepared, and SUS304 plate (manufactured by Nilaco Corporation) was adhered as a current collector. In a vessel having an oxygen-intake hole, so as to laminate an air electrode, a separator, a negative electrode, and a negative electrode current collector in this order from the intake hole side, the respective members were housed. The electrolytic solution was charged in the separator, and a lithium-air battery was prepared.

### Example 2

Ag₂O and B₂O₃ were mixed to be 25:75 by mole ratio, thereby Ag₂O—B₂O₃-based glass (hereinafter, referred to as 25Ag₂O-75B₂O₃ glass) was prepared. Except that in place of the 50Ag₂O-50B₂O₃ glass, 25Ag₂O-75B₂O₃ glass was used, in a manner the same as that of Example 1, an air electrode and a lithium-air battery were prepared. A ratio of the non-crosslinking B—O bonds in the 25Ag₂O-75B₂O₃ glass was 25% (see Table 1).

### Comparative Example 1

Except that in place of 50Ag₂O-50B₂O₃ glass, Ag₂O crystal was used, in a manner the same as that of Example 1, an air electrode and a lithium-air battery were manufactured. A ratio of the non-crosslinking B—O bonds in Ag₂O crystal was 0% (see Table 1).

TABLE 1

| | | Ratio of |
|---|---|---|
| | | non-crosslinking |
| | | B—O bonds (%) |
| Example 1 | 50Ag₂O—50B₂O₃ glass | 50 |
| Example 2 | 25Ag₂O—75B₂O₃ glass | 25 |
| Comparative Example 1 | Ag₂O crystal | 0 |

Lithium-air batteries of the Examples and Comparative Example were evaluated in a manner shown below. Firstly, the lithium-air batteries were held at 60° C. for 3 hrs after the preparation thereof. Next, in a pure oxygen atmosphere (99.9%, manufactured by Taiyo Nippon Sanso Corporation), voltages when the lithium-air batteries were held at the respective current densities in the range of 0 to 0.2 mA/cm² for 15 minutes were measured. Results thereof are shown in FIG. 2. As shown in FIG. 2, lithium-air batteries of Examples 1 and 2 have excellent battery performance compared with that of the lithium-air battery of Comparative Example 1. In particular, the lithium-air battery of Example 1 was observed to have a new potential flat part in a high voltage region in the vicinity of 3 V, and was confirmed to have high output characteristics, Since the potential flat part in the low current density region is a potential region higher than a Li insertion potential (about 2.8 V) to Ag₂O, it is considered to be caused by the generation of LiOH, and it is assumed that B—O⁻ . . . Ag⁺ bonds that are present abundantly in an air electrode of Example 1 and have a non-crosslinking oxygen, after a reducing reaction with hydrogen, formed B—OH bonds, and promoted generation of LiOH. In a lithium-air battery of Comparative Example 1, it is considered that since hydrogen-reducing capacity of Ag₂O is high, hydrogen is reduced to water, and generation of LiOH was not promoted. Rather, in the air battery of Comparative Example 1, it is considered that generated water reacts with a lithium negative electrode, a resistant layer such as LiOH was formed on a negative electrode, and the battery deterioration was accelerated.

What is claimed is:

1. An air electrode for a metal-air battery that includes the air electrode, a negative electrode, and an electrolyte provided between the air electrode and the negative electrode, the air electrode comprising:
non-crosslinking oxygen-containing MₓO_{y}-based glass that contains a non-crosslinking oxygen that is an oxygen (O) that bonds to M constituting MₓO_{y}-based glass, and bonds to Ag,
MₓO_{y} of the MₓO_{y}-based glass being at least one kind selected from the group consisting of B₂O₃, P₂O₅, SiO₂, GeO₂, and Al₂O₃.

2. The air electrode for a metal-air battery according to claim 1, wherein the non-crosslinking oxygen-containing MₓO_{y}-based glass has, among oxygens (O) that bonds to the M, 25% or more of the non-crosslinking oxygens.

3. The air electrode for a metal-air battery according to claim 1, wherein the non-cross linking oxygen-containing MₓO_{y}-based glass has, among oxygens (O) that bond to the M, 50% or more of the non-crosslinking oxygens.

4. The air electrode for a metal-air battery according to claim 1, wherein the MₓO_{y}-based glass is B₂O₃-based glass.

5. The air electrode for a metal-air battery according to claim 4, wherein the non-crosslinking oxygen-containing MₓO_{y}-based glass is Ag₂O—B₂O₃-based glass.

6. The air electrode for a metal-air battery according to claim 1, wherein the negative electrode of the metal-air battery contains lithium metal.

7. A metal-air battery comprising:
the air electrode of claim 1;
a negative electrode; and
an electrolyte provided between the air electrode and the negative electrode.
